(19) United States
(12) Patent Application Publication
(10) Pub. No.: US 2015/0033107 A1
(43) Pub. Date: Jan. 29, 2015

(54) METHOD AND DEVICE FOR ADDING FILLABLE FORM FIELD INTO PDF DOCUMENT STATIC FORM

(71) Applicant: FOXIT CORPORATION, Fuzhou City (CN)

(72) Inventor: Yuqian Xiong, Fuzhou City (CN)

(73) Assignee: FOXIT CORPORATION, Fuzhou City (CN)

(21) Appl. No.: 14/378,889

(22) PCT Filed: Dec. 7, 2012
(86) PCT No.: PCT/CN2012/001638

§ 371 Date: Aug. 14, 2014

(30) Foreign Application Priority Data
Feb. 27, 2012 (CN) 2012100465300

(51) Int. Cl. G06F 17/24

(52) U.S. Cl. CPC G06F 17/243
USPC 715/225

(57) ABSTRACT

A method and device for adding a fillable form field into a PDF document static form. The method comprises the following steps: receiving the click of a user on a position in a static form where a form field is required to be added, and judging the size and the shape of the blank space around the clicked position by extending upwards, downwards, leftwards and rightwards from the clicked position; prompting and receiving the selection by the user of the type of the form field which is required to be added; and according to the type of the form field which is selected by the user and the size and the shape of the blank space around the clicked position, adding the form field.

### TECHNICAL FIELD

The present invention relates to generating a form, and more particularly, to a method and a device for adding a fillable form field to a static form of a PDF document.

### BACKGROUND

Generally, when customers start to design a PDF (Portable Document Format) form, the customers may select a document format easy to edit for designing a layout. And then the document format easy to edit is transformed into a PDF document format. Alternatively, a document based on an existing paper form is even edited with scissors and glue, and then it is scanned into a document in a PDF document format.

Then, a fillable form field is added into the above static form. That is, a static PDF form are converted to a fillable PDF form. With regard to the above demands, a location, a shape, and a size of the fillable form field, which are required in said form, has already been designed. However, there are a lot of troubles for customers, and said customers are required to spend much time and effort to add a fillable form field, because they have to add the fillable form field manually.

### SUMMARY OF THE INVENTION

The present invention provides a method and a device for adding a fillable form field into a static form of a PDF document, so as to facilitate adding a fillable form field into a PDF document static form conveniently and quickly.

To achieve the above object, the present invention provides a method for adding a fillable form field to a static form of a PDF document, wherein it comprises the following steps:

Accepting a clicking of a user at a position of a form field to be added in the static form, extending upward, downward, leftward and rightward from the clicked position to determine a size and a shape of a blank region around the clicked position.

Prompting and accepting a selection of the user for a type of the form field to be added.

Adding the form field based on the selection of the user for the type of the form field to be added, and the size and the shape of the blank region around the clicked position.

Further, the method comprises the following steps:

Accepting an adjustment to the form field added by the user.

To achieve the above object, the present invention further provides a device for adding a fillable form field to a static form of a PDF document, it comprises:

A location selection unit, which is applied for accepting a click of the user at a position of a form field to be added in the static form, extending upward, downward, leftward and rightward from the clicked position to determine a size and a shape of a blank region around the clicked position.

A type selection unit, which is applied for prompting and accepting a selection of the user for a type of the form field to be added.

An adding unit, which is applied for adding a form field based on the type of the form field selected by the user, and the size and the shape of the blank region around the clicked position.

Further, the device also comprises:

An adjusting unit, which is applied for accepting an adjustment to the form field added by the user.

In the above embodiments, after accepting a click of the user at a position of a form field to be added, it may estimate automatically a size and a shape of a blank region around the clicked position. And add a form field automatically according to the type of the form field selected by the user. Thereby, it reduces the difficulty and the operation time of adding a form field, then it increases the efficiency of making a form.

### DESCRIPTION OF THE DRAWINGS

In order to clearly illustrate the technical solution of the embodiments of the present invention or the prior art, the drawings accompanying the description of the embodiments of the present invention or the prior art are briefly described as following. Obviously, the given accompanying drawings are only parts of embodiments of the present invention, so that, those skilled in the art could get other accompanying drawings in accordance with the given accompanying drawings without devoting a creative work.

FIG. 1 is a flow diagram of the method for adding a fillable form field into a static form of a PDF document according to an embodiment of the present invention;

FIGS. 2a, 2b, and 2c are the screenshots of adding a fillable form field into a static form of a PDF document according to an embodiment of the present invention;

FIG. 3 is a block diagram of a device of adding a fillable form field into a static form of a PDF document according to an embodiment of the present invention.

### DETAILED DESCRIPTION

With reference to the accompanying drawings, the technical solution of the embodiments of the present invention is described clearly and completely as following. Obviously, the given embodiments are only parts of the embodiments of the present invention, but not all embodiments of the present invention. Based on the embodiments of the present invention, all other embodiments which can be obtained without devoting a creative work by those skilled in the art should be deemed to fall in within the scope of the present invention.

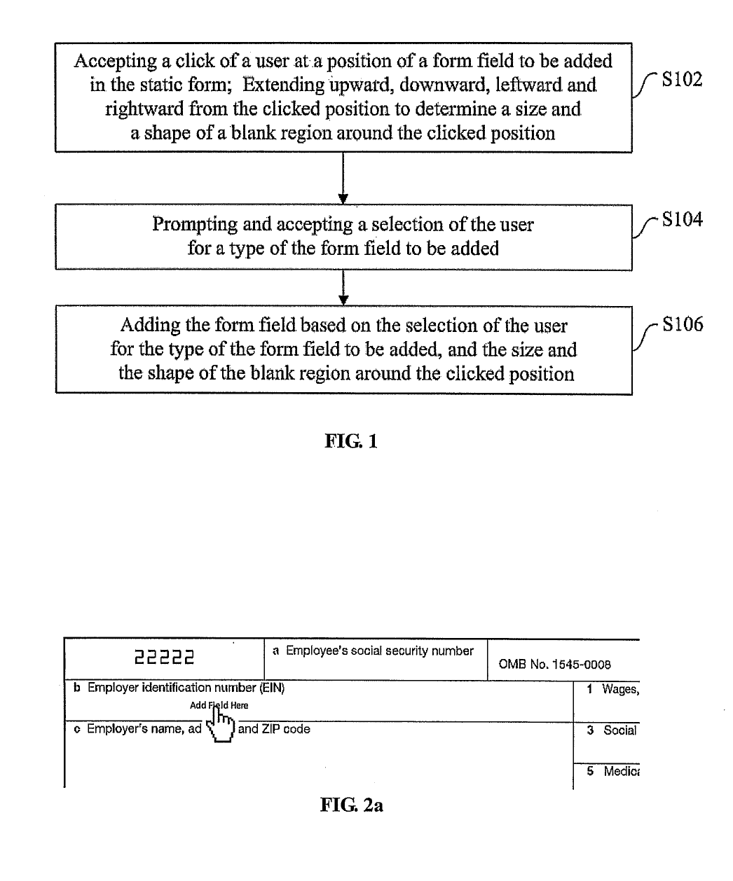

FIG. 1 is a flow diagram of the method for adding a fillable form field into a static form of a PDF document according to an embodiment of the present invention. As shown in FIG. 1, the method comprises the following steps:

S102, Accepting a click of a user at a position of a form field to be added in the static form; Extending upward, downward, leftward and rightward from the clicked position to determine a size and a shape of a blank region around the clicked position.

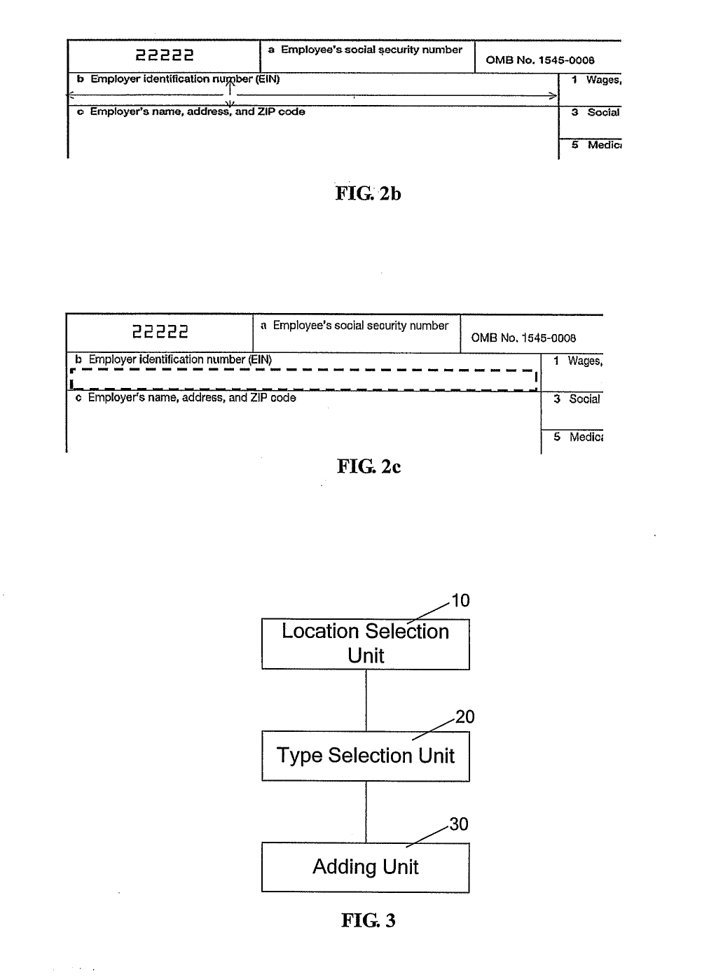

Shown in FIG. 2a, in the PDF static form, a click of the user is accepted at a position of a form field to be added. Shown in FIG. 2b, a daemon (background program) determines the size and the shape of the blank region of the form field to be added based on the circumstances around the clicked position automatically.

S104, Prompting and accepting a selection of the user for a type of the form field to be added.

S106, Adding the form field based on the selection of the user for the type of the form field to be added, and the size and the shape of the blank region around the clicked position.

In the present embodiment, after accepting a click of the user at a position of a form field to be added, the method may determine automatically a size and a shape of a blank region around the clicked position, and add a form field automatically according to a type of the form field selected by the user. Thereby, the method reduces the difficulty of adding a form field, reduces the operation time of the user, and increases the efficiency of making a form.

Further, for the convenience of users to make appropriate adjustments, the above method also comprises the following steps:

Accepting an adjustment to the form field added by the user.

Shown in FIG. 2c, the area of the dotted box is the added form field, and it could accept user's adjustments.

FIG. 3 is a block diagram of a device of adding a fillable form field into a static form of a PDF document according to an embodiment of the present invention. As shown in FIG. 3, the device comprising:

A location selection unit 10, which is applied for accepting a click of the user at the position of a form field to be added in the static form, extending upward, downward, leftward and rightward from the clicked position to determine a size and a shape of a blank region around the clicked position.

A type selection unit 20, which is applied for prompting and accepting a selection of the user for a type of the form field to be added.

An adding unit 30, which is applied for adding a form field based on the type of the form field selected by the user, and the size and the shape of the blank region around the clicked position.

In the present embodiment, after accepting a click of the user at a position of a form field to be added, the device may determine automatically a size and a shape of a blank region around the clicked position, and add a form field automatically according to the type of the form field selected by the user. Thereby, the device reduces the difficulty of adding a form field, reduces the operation time of the user, and increases the efficiency of making a form.

Further, for the convenience of users to make appropriate adjustments, the above device also comprises:

An adjusting unit, which is applied for accepting an adjustment to the form field added by the user.

Those skilled in the art can understand it as the following: the accompanying drawings are only a schematic example of the embodiments, the modules or processes in the accompanying drawings are not essential to the embodiments of the present invention.

Those skilled in the art can understand that: the modules of the device of the embodiments may be both distributed in the device of the present embodiments according to the description of the present embodiments, and be distributed in one or multiple devices of an embodiment different from the present embodiments based on corresponding variations. The Modules of the above embodiments can be combined into one module, and may be further separated into a plurality of sub-modules.

Finally, it should be noted that: the above embodiments are merely to illustrate the technical aspects of the present invention, but not intended to limit; despite the reference to the aforementioned embodiments of the present invention has been described in detail, those skilled in the art should understand: it is still possible that the technical solution described in the foregoing embodiment is modified, or some technical features are replaced in equivalent; while these modifications or replacements do not essentially depart corresponding technical solutions from the spirit and scope of the invention to implement technical solutions.

1. A method for adding a fillable form field into a static form of a PDF document, wherein it comprises the steps of:
accepting a click of a user at a position of a form field to be added in the static form;
extending upward, downward, leftward and rightward from the clicked position to determine a size and a shape of a blank region around the clicked position;
prompting and accepting a selection of the user for a type of the form field to be added; and
adding the form field based on the selection of the user for the type of the form field to be added, and the size and the shape of the blank region around the clicked position.

2. The method according to claim 1, wherein further comprising following steps:
accepting an adjustment to the form field added by the user.

3. A device for adding a fillable form field into a static form of a PDF document, wherein it comprises:
a location selection unit, which is applied for accepting a click of a user at the position of a form field to be added in the static form, extending upward, downward, leftward and rightward from the clicked position to determine a size and a shape of a blank region around the clicked position;
a type selection unit, which is applied for prompting and accepting a selection of the user for a type of the form field to be added; and
an adding unit, which is applied for adding a form field based on the type of the form field selected by the user, and the size and the shape of the blank region around the clicked position.

4. The device according to claim 3, wherein it comprises:
an adjusting unit, which is applied for accepting an adjustment to the form field added by the user.
